(19) United States
(12) Patent Application Publication
(10) Pub. No.: US 2026/0066562 A1
(43) Pub. Date: Mar. 5, 2026

(54) POWER CONNECTOR AND POWER ADAPTOR HAVING THE SAME

(71) Applicant: LITE-ON TECHNOLOGY CORPORATION, Taipei (TW)

(72) Inventors: Chou-Yu CHIEN, Taipei (TW); Chun-Pei WU, Taipei (TW)

(21) Appl. No.: 19/176,226

(22) Filed: Apr. 11, 2025

Related U.S. Application Data
(60) Provisional application No. 63/687,312, filed on Aug. 27, 2024.

(30) Foreign Application Priority Data
Dec. 27, 2024 (CN) 202423250560.0

(51) Int. Cl. H01R 12/72; H01R 13/502

(52) U.S. Cl. CPC H01R 12/722; H01R 13/502

(57) ABSTRACT

A power connector is provided in the present invention. The power connector is adapted to be connected with a circuit board of a power adaptor. The power connector comprises a base, a conductive pin and a conductive elastic component. The conductive pin is disposed in the base. The conductive elastic component is electrically connected between the circuit board and the conductive pin. The conductive pin penetrates through the conductive elastic component.

This application claims the benefits of U.S. provisional application Serial No. 63/687,312, filed on August 27, 2024 and People’s Republic of China application Serial No. 202423250560.0, filed on December 27, 2024. The contents of these applications are incorporated herein by reference.

### TECHNICAL FIELD

The present invention relates to a power connector and a power adaptor having the same.

### BACKGROUND

Conventionally, a power adapter includes an AC power connector to allow the power adapter to be connected with an external power cord. Typically, the AC power connector is electrically connected to a circuit board of the power adapter via a live wire (L) cable and a neutral wire (N) cable. However, this design presents several unavoidable drawbacks. For example, it requires sufficient space for routing the live wire and neutral wire cables, which affects the internal component layout of the power adapter. Further, when the live wire and neutral wire cables are positioned too close to certain internal components of the power adapter, electromagnetic interference (EMI) may occur, thereby adversely affecting performance. Another conventional approach involves installing conductive elastic pieces in the AC power connector, which are then directly inserted into and soldered onto the circuit board. However, this approach may lead to cracks at the solder joints on the circuit board due to repeated insertion and removal of the external power cord from the AC power connector, thereby compromising product reliability.

In view of the foregoing, there exists a need in the art for an improved design to overcome the aforementioned drawbacks.

### SUMMARY

According to an aspect of the present invention, a power connector is provided. The power connector is adapted to be connected with a circuit board of a power adapter. The power connector comprises a base, a conductive pin and a conductive elastic component. The conductive pin is disposed in the base. The conductive elastic component is electrically connected between the circuit board and the conductive pin. The conductive pin penetrates through the conductive elastic component.

According to another aspect of the present invention, a power adapter is provided. The power adapter comprises a casing, a circuit board and a power connector. The circuit board is disposed in the casing. The power connector is disposed in the casing. The power connector comprises a base, a conductive pin and a conductive elastic component. The conductive pin is disposed in the base. The conductive elastic component is electrically connected between the circuit board and the conductive pin. The conductive pin penetrates through the conductive elastic component.

The above and other aspects of the present invention will become better understood with regard to the following detailed description of the preferred but non-limiting embodiment(s). The following description is made with reference to the accompanying drawings.

### BRIEF DESCRIPTION OF THE DRAWINGS

FIG. 1A and FIG. 1B illustrate perspective views of a power connector according to a first embodiment of the present invention.

FIG. 1C and FIG. 1D illustrate exploded views of the power connector according to the first embodiment of the present invention.

FIG. 1E illustrates the power connector of the first embodiment and a circuit board with which it is adapted to be connected.

FIG. 1F illustrates a side view of a conductive elastic component included in the power connector.

FIG. 2A illustrates a perspective view of a power connector according to a second embodiment of the present invention.

FIG. 2B illustrates an exploded view of the power connector according to the second embodiment of the present invention.

FIG. 2C illustrates the power connector of the second embodiment and a circuit board with which it is adapted to be connected.

FIG. 3A and FIG. 3B illustrates a power connector of the third embodiment and a circuit board with which it is adapted to be connected.

FIG. 4A and FIG. 4B illustrate perspective views of a power connector according to a fourth embodiment of the present invention.

FIG. 4C and FIG. 4D illustrate exploded views of the power connector according to the fourth embodiment of the present invention.

FIG. 4E illustrates the power connector of the fourth embodiment and a circuit board with which it is adapted to be connected.

FIG. 5A illustrates a perspective view of a power connector according to a fifth embodiment of the present invention.

FIG. 5B illustrates an exploded view of the power connector according to the fifth embodiment of the present invention.

FIG. 5C illustrates the power connector of the fifth embodiment and a circuit board with which it is adapted to be connected.

FIG. 6A and FIG. 6B illustrate a casing and a power connector of a power adapter according to a sixth embodiment of the present invention.

FIG. 6C illustrates a top view of the power adapter according to the sixth embodiment of the present invention.

FIG. 7A illustrates a perspective view of a power adapter according to a seventh embodiment of the present invention.

FIG. 7B illustrates an exploded view of the power adapter according to the seventh embodiment of the present invention.

FIG. 7C illustrates a partial view of the power adapter according to the seventh embodiment of the present invention.

FIG. 8A illustrates a perspective view of a power adapter according to an eighth embodiment of the present invention.

FIG. 8B illustrates an exploded view of the power adapter according to the eighth embodiment of the present invention.

FIG. 8C illustrates a perspective view of a power connector of the power adapter according to the eighth embodiment of the present invention.

### DETAILED DESCRIPTION

Detailed descriptions of the embodiments of the specification are disclosed below with reference to the accompanying drawing. A portion from the said detailed descriptions, any embodiments in which the present invention can be used as well as any substitutions, modifications or equivalent changes of the said embodiments are within the scope of the disclosure, and the descriptions and definitions in the claims shall prevail. In the following detailed description, for purposes of explanation, numerous specific details are set forth in order to provide a thorough understanding of the disclosed embodiments. It will be apparent, however, that one or more embodiments may be practiced without these specific details. Further, well-known common steps or components are not described in detail to avoid unnecessarily limiting the present invention. The same or similar elements in the figures are represented by the same or similar sign.

### First embodiment:

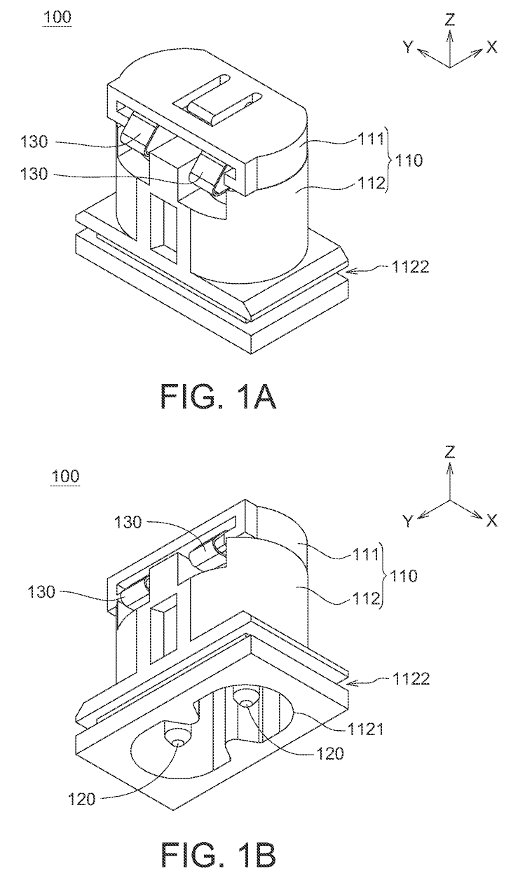

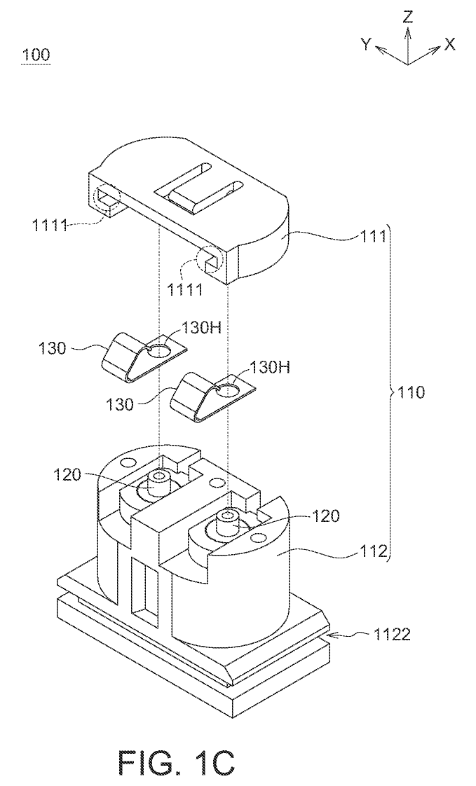

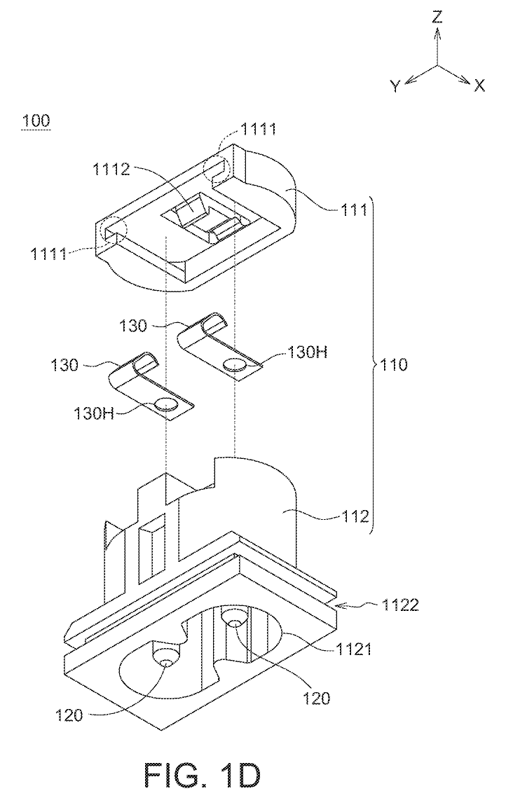

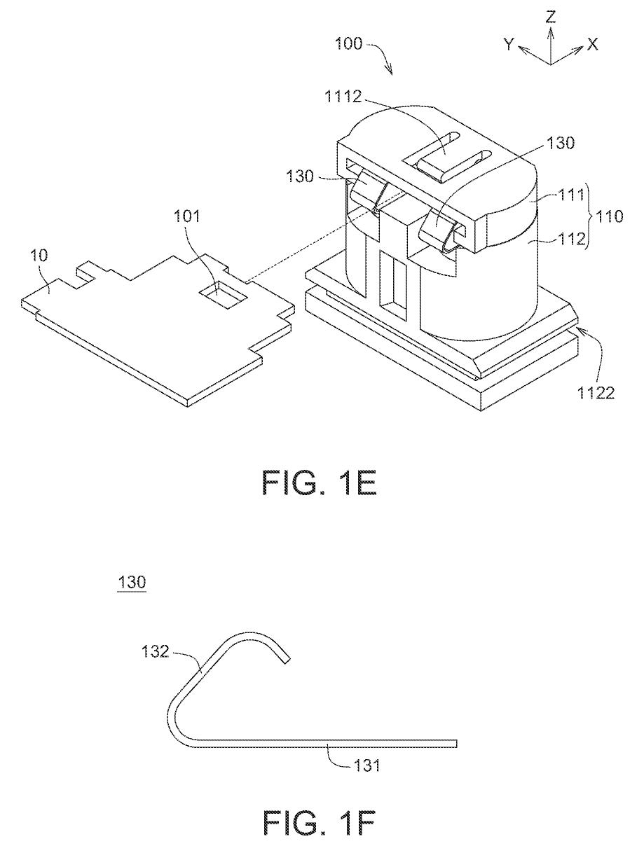

Please refer to FIG. 1 to FIG. 1F, which illustrate a power connector 100 according to the first embodiment of the present invention. FIG. 1A and FIG. 1B illustrate perspective views of the power connector 100. FIG. 1C and FIG. 1D illustrate exploded views of the power connector 100. FIG. 1E illustrates the power connector 100 and a circuit board 10 with which it is adapted to be connected. FIG. 1F illustrates a side view of a conductive elastic component 130 of the power connector 130.

The power connector 100 of this embodiment, for example, is an AC power connector and may serve as the AC inlet of a power adapter. The power connector 100 is adapted to be connected with the circuit board 10 of a power adapter. The power connector 100 comprises a base 110, a conductive pin 120 and a conductive elastic component 130. The conductive pin 120 is disposed in the base 110. In this embodiment, the power connector 100 comprises two conductive pins 120, which may correspond respectively to the live wire (L) and neutral wire (N) of the power supply. The conductive pin 120 is made of a conductive metal material. The conductive elastic component 130 is electrically connected between the circuit board 10 and the conductive pin 120. In this embodiment, the power connector 100 comprises two conductive elastic components 130. The two conductive pins 120 respectively penetrate through the two conductive elastic components 130. Specifically, the conductive elastic component 130 is provided with a through-hole 130H. The conductive pin 120 passes through the through-hole 130H to form an electrical connection with the conductive elastic component 130.

The base 110 is made of an insulated plastic material. The base 110 may include a cover portion 111 and a main body portion 112, and the cover portion 111 and the main body portion 112 are fixedly connected to each other. The cover portion 111 and the main body portion 112 may be fixedly connected through ultrasonic welding. The conductive pin 120 is exposed from an open area 1121 at the bottom of the main body portion 112. The conductive elastic component 130 is disposed between the cover portion 111 and the main body portion 112. The conductive elastic component 130 may protrude from the cover portion 111. An accommodating space is formed between the conductive elastic component 130 and the cover portion 111 for the circuit board 10 to be inserted and fixed. Specifically, the cover portion 111 has a sliding rail structure 1111, and the circuit board 10 may be inserted into the sliding rail structure 1111. When the circuit board 10 is inserted into the sliding rail structure 1111, the circuit board 10 is in contact with and presses down the conductive elastic component 130. Due to its elasticity, the conductive elastic component 130 deforms under pressure to abut against the circuit board 10, ensuring a stable electrical connection between the circuit board 10 and the conductive elastic component 130.

Further, the cover portion 111 may have a hook structure 1112 corresponding to a through-hole structure 101 of the circuit board 10. When the circuit board 10 is inserted into the cover portion 111, the hook structure 1112 can engage with the through-hole structure 101, thereby making the installation of the circuit board 10 onto the base 110 more secure, but it is not limited thereto. In other embodiments, the hook structure may alternatively be formed on the main body portion 112, as long as the base 110 is provided with a hook structure.

The conductive elastic component 130 is made of a conductive metal material. The conductive elastic component 130 may include a fixed portion 131 and an abutting portion 132, and the abutting portion 132 extends and bends from the fixed portion 131. The conductive elastic component 130 may be a flat spring structure. The aforementioned through-hole 130H is formed in the fixed portion 131, meaning that the conductive pin 120 penetrates through the fixed portion 131. The abutting portion 132 abuts against the circuit board 10, providing a contact place when the circuit board 10 is inserted into the cover portion 111. The contact between the abutting portion 132 and the circuit board 10 may be line contact or surface contact. The elastic deformation of the bent structure of the abutting portion 132 enables close contact between the circuit board 10 and the conductive elastic component 130, ensuring a stable electrical connection.

Further, the main body portion 112 may have a groove structure 1122. The groove structure 1122 is arranged around the bottom side of the main body portion 112. The groove structure 1122 may serve as a fixing structure when the power connector 100 is disposed in the power adapter.

### Second embodiment:

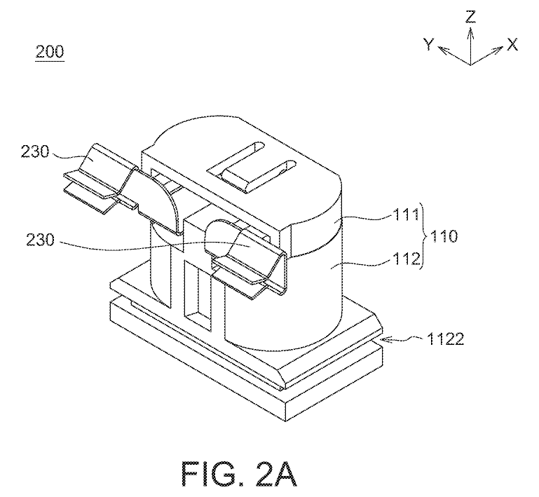

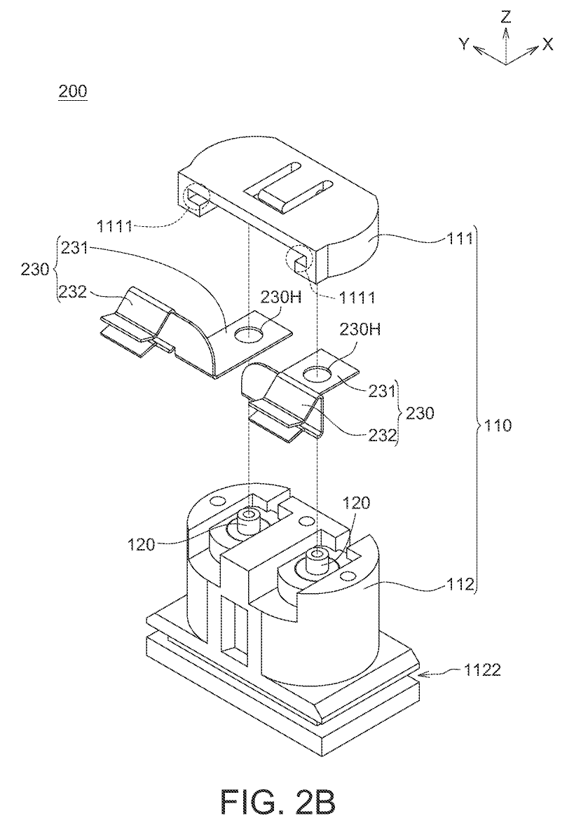

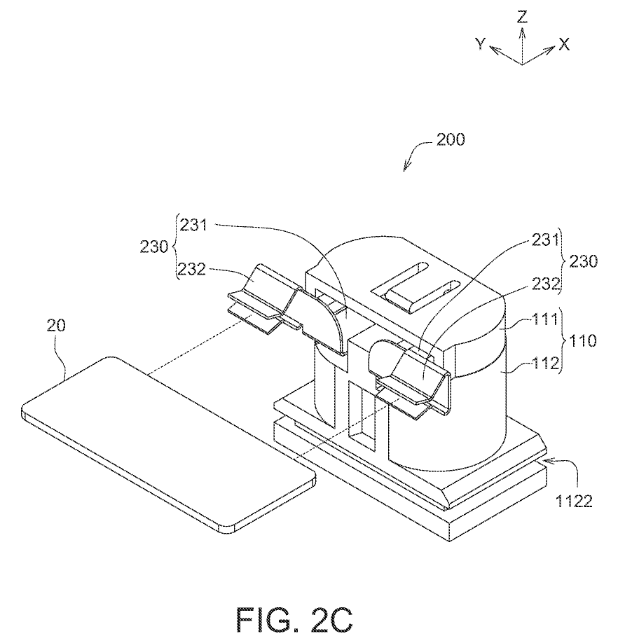

Please refer to FIG. 2A to FIG. 2C, which illustrate a power connector 200 according to the second embodiment of the present invention. FIG. 2A illustrates a perspective view of the power connector 200. FIG. 2B illustrates an exploded view of the power connector 200. FIG. 2C illustrates the power connector 200 and a circuit board 20 with which it is adapted to be connected.

The power connector 200 of this embodiment, for example, is an AC power connector and may serve as the AC inlet of a power adapter. The power connector 200 is adapted to be connected with the circuit board 20 of a power adapter. The power connector 200 comprises the aforementioned base 110, the aforementioned conductive pin 120, and a conductive elastic component 230. That is, the difference between the power connector 200 of this embodiment and the power connector 100 of the first embodiment lies in the different configurations of the conductive elastic component. The conductive elastic component 230 is electrically connected between the circuit board 20 and the conductive pin 120. In this embodiment, the power connector 200 comprises two conductive pins 120 and two conductive elastic components 230. The two conductive pins 120 respectively penetrate through the two conductive elastic components 230. Specifically, the conductive elastic component 230 is provided with a through-hole 230H. The conductive pin 120 passes through the through-hole 230H to form an electrical connection with the conductive elastic component 230.

The conductive elastic component 230 is made of a conductive metal material. The conductive elastic component 230 is disposed between the cover portion 111 and the main body portion 112. The conductive elastic component 230 may protrude from the cover portion 111, and its protrusion extent is greater than that of the aforementioned conductive elastic component 130. The conductive elastic component 230, for example, is made of a conductive metal material. Specifically, the conductive elastic component 230 includes a fixed portion 231 and a clamping portion 232. The fixed portion 231 is accommodated in an accommodating space between the cover portion 111 and the main body portion 112. The conductive pin 120 penetrates through the fixed portion 231, and the aforementioned through-hole 230H is formed in the fixed portion 231, meaning that the conductive pin 120 passes through the fixed portion 231. The clamping portion 232 extends from the fixed portion 231 and protrudes from the base 110. The clamping portion 232 may be a long-tail clip structure, allowing the circuit board 20 to be clamped within the clamping portion 232. The clamping action provided by the clamping portion 232 enables close contact between the circuit board 20 and the conductive elastic component 230, ensuring a stable electrical connection. In this embodiment, the circuit board 20 is not inserted into the base 110 but can be positioned externally to the base 110. Since the circuit board 20 does not need to be inserted into the base 110 for fixation, it is not restricted by the distance between the sliding rail structures 1111 of the cover portion 111. Therefore, the power connector 200 of this embodiment can be applied to larger circuit boards.

### Third Embodiment:

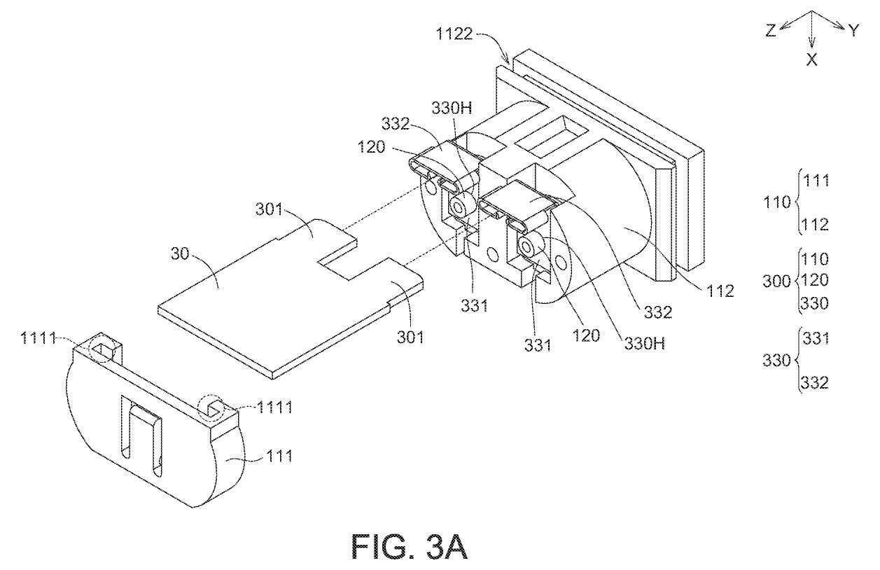

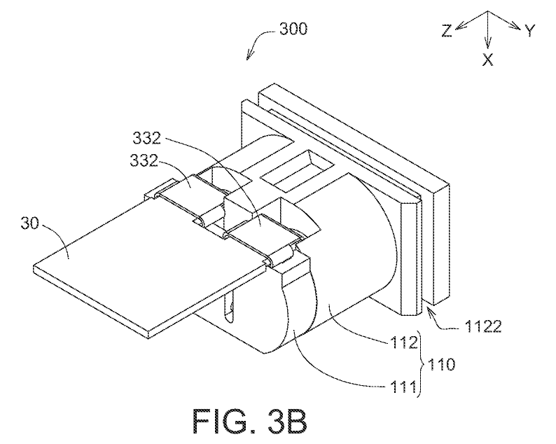

Please refer to FIG. 3A to FIG. 3B, which illustrate a power connector 300 according to the third embodiment of the present invention. FIG. 3A and 3B show the power connector 300 and a circuit board 30 with which it is adapted to be connected.

The power connector 300 of this embodiment, for example, is an AC power connector and may serve as the AC inlet of a power adapter. The power connector 300 is adapted to be connected with a circuit board 30 of a power adapter. The power connector 300 includes the aforementioned base 110, the aforementioned conductive pin 120, and a conductive elastic component 330. That is, the difference between the power connector 300 of this embodiment and the power connector 100 of the first embodiment lies in the different configurations of the conductive elastic component. The conductive elastic component 330 is electrically connected between the circuit board 30 and the conductive pin 120. In this embodiment, the power connector 300 comprises two conductive pins 120 and two conductive elastic components 330. The two conductive pins 120 respectively penetrate through the two conductive elastic components 330. Specifically, the conductive elastic component 330 is provided with a through-hole 330H, through which the conductive pin 120 passes to form an electrical connection with the conductive elastic component 330.

The conductive elastic component 330 is made of a conductive metal material. The conductive elastic component 330 is disposed between the cover portion 111 and the main body portion 112. The conductive elastic component 330 may protrude from the cover portion 111. Specifically, the conductive elastic component 330 includes a fixed portion 331 and a slot portion 332. The fixed portion 331 is accommodated in the accommodating space between the cover portion 111 and the main body portion 112. The conductive pin 120 penetrates through the fixed portion 331, with the aforementioned through-hole 330H formed in the fixed portion 331. The slot portion 332 extends and bends from the fixed portion 331. The extension direction of the slot portion 332 after bending is parallel to the axial direction of the conductive pin 120. That is, the fixed portion 331 and the slot portion 332 may be vertically connected, forming an L-shaped structure. The slot portion 332 may abut against the cover portion 111 and even shield the sliding rail structure 1111 of the cover portion 111. Two protruding sections 301 at the edge of the circuit board 30 are respectively inserted into the corresponding slot portions 332. The clamping effect provided by the slot portion 332 enables close contact between the circuit board 30 and the conductive elastic component 330, ensuring a stable electrical connection. In this embodiment, the circuit board 30 is also not inserted into the base 110 but may be positioned externally to the base 110. Since the circuit board 30 does not need to be inserted into the base 110 for fixation, it is not limited by the spacing between the sliding rail structures 1111 of the cover portion 111. Therefore, as long as the distance between the slot portions 332 corresponds to the distance between the protruding sections 301, the power connector 300 of this embodiment can be applied to larger circuit boards with protruding sections corresponding to the slot portions 332.

### Fourth embodiment:

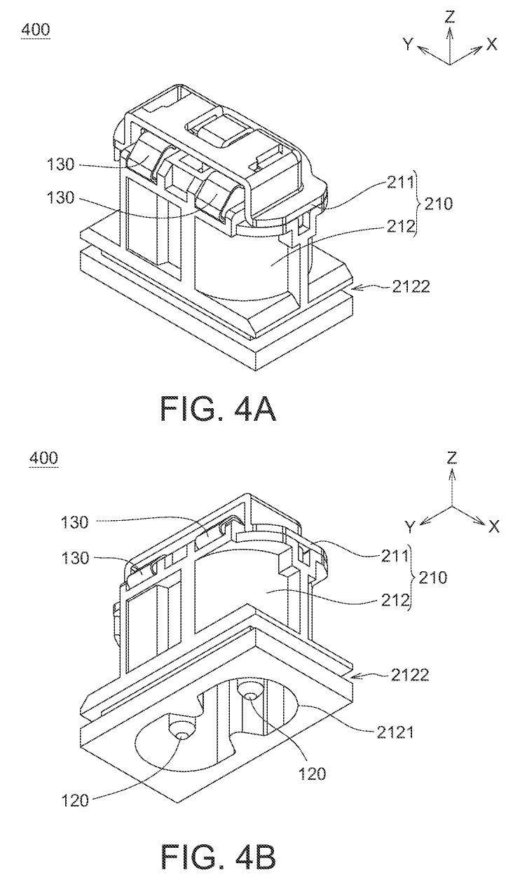

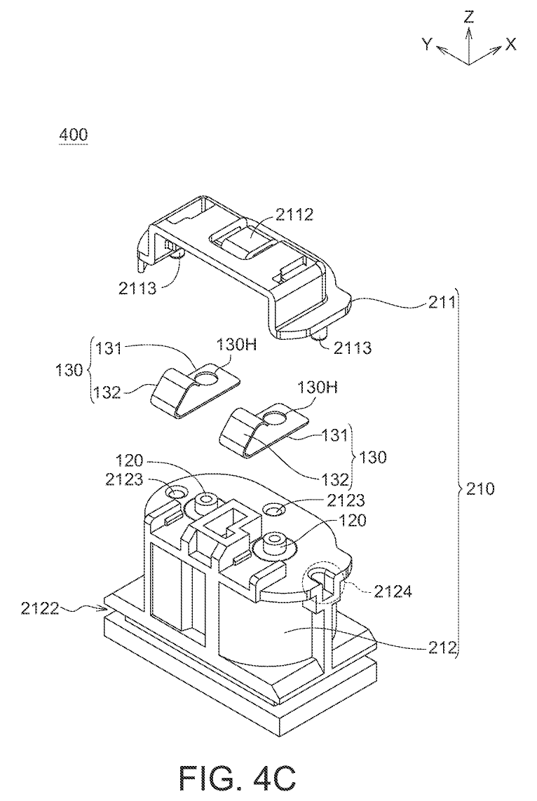

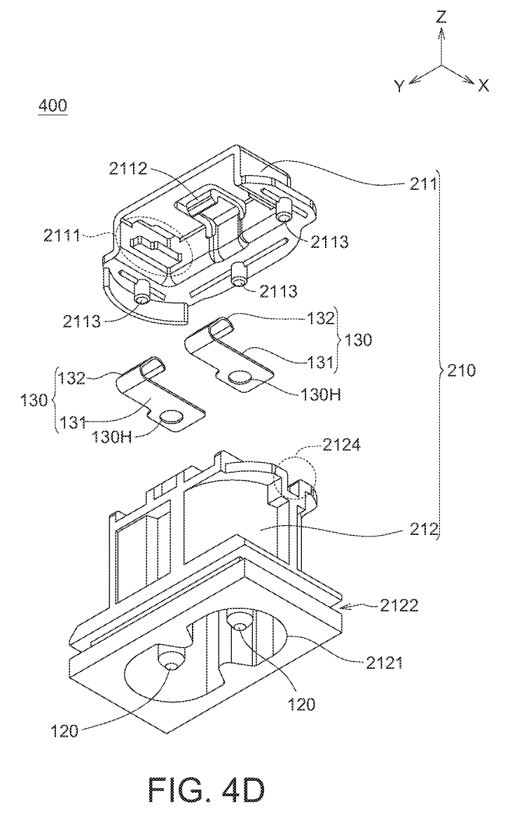

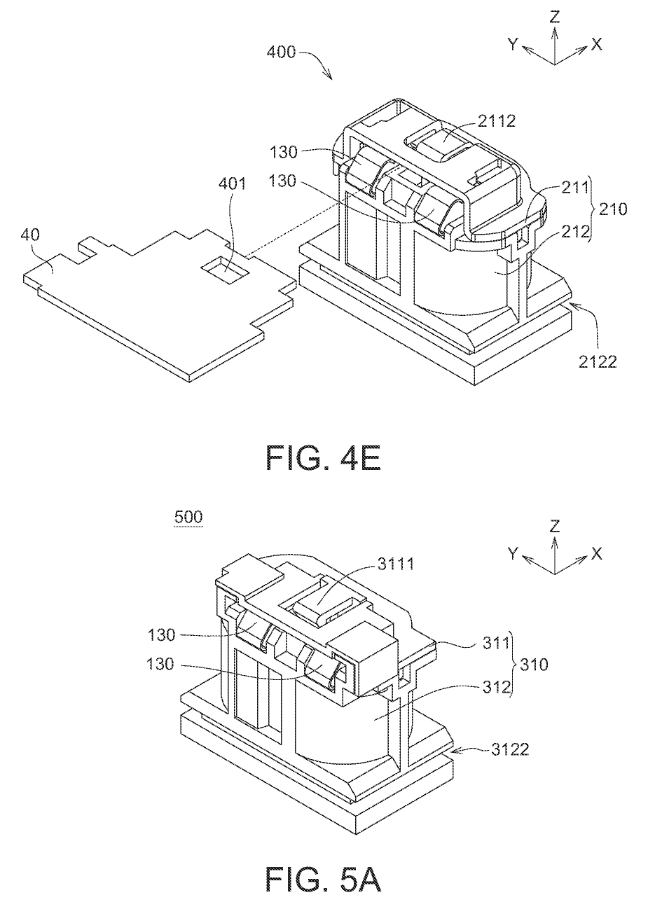

Please refer to FIG. 4A to FIG. 4E, which illustrate a power connector 400 according to the fourth embodiment of the present invention. FIG. 4A and FIG. 4B show perspective views of the power connector 400. FIG. 4C and FIG. 4D show exploded views of the power connector 400. FIG. 4E illustrates the power connector 400 and the circuit board 40 with which it is adapted to be connected.

The power connector 400 of this embodiment, for example, is an AC power connector and may serve as the AC inlet of a power adapter. The power connector 400 is adapted to be connected with the circuit board 40 of a power adapter. The power connector 400 comprises a base 210, the aforementioned conductive pin 120, and the aforementioned conductive elastic component 130. That is, the difference between the power connector 400 of this embodiment and the power connector 100 of the first embodiment lies in the different configurations of the base. The conductive pin 120 is disposed in the base 210. The conductive elastic component 130 is electrically connected between the circuit board 40 and the conductive pin 120. The base 210, for example, is made of an insulated plastic material. The base 210 may include a cover portion 211 and a main body portion 212, which are fixedly connected to each other. The cover portion 211 and the main body portion 212 may be fixedly connected through ultrasonic welding. The cover portion 211 may have protruding post structures 2113. The main body portion 212 may have blind-hole structures 2123 and a recess structure 2124, corresponding to the protruding post structures 2113. When the cover portion 211 and the main body portion 212 are fixedly connected, two of the protruding post structures 2113 are inserted into the corresponding blind-hole structures 2123, and one of the protruding post structures 2113 is fitted into the corresponding recess structure 2124.

The conductive pin 120 may be exposed from an open area 2121 at the bottom of the main body portion 212. The conductive elastic component 130 is disposed between the cover portion 211 and the main body portion 212. The conductive elastic component 130 may protrude from the cover portion 211. An accommodating space is formed between the conductive elastic component 130 and the cover portion 211 for the circuit board 40 to be inserted and fixed. The cover portion 211 may have a sliding rail structure 2111. The sliding rail structure 2111 is formed on the two inner walls of the cover portion 211 and is composed of inwardly protruding ribs and a top cover of the cover portion 211. The circuit board 40 may be inserted into the sliding rail structure 2111. When the circuit board 40 is inserted into the sliding rail structure 2111, the circuit board 40 is in contact with and presses down the conductive elastic component 130. Due to its elasticity, the conductive elastic component 130 deforms under pressure to abut against the circuit board 40, ensuring a stable electrical connection between the circuit board 40 and the conductive elastic component 130.

Further, the cover portion 211 may have a hook structure 2112, which corresponds to a through-hole structure 401 of the circuit board 40. When the circuit board 40 is inserted into the cover portion 211, the hook structure 2112 can be secured in the through-hole structure 401, making the installation of the circuit board 40 onto the base 210 more secure, but it is not limited thereto. In other embodiments, the hook structure may alternatively be formed on the main body portion 212, as long as the base 210 is provided with a hook structure.

When the circuit board 40 is inserted into the cover portion 211, the abutting portion 132 of the conductive elastic component 130 abuts against the circuit board 40. That is, the abutting portion 132 provides a contact place when the circuit board 40 is inserted into the cover portion 211. The contact between the abutting portion 132 and the circuit board 40 may be line contact or surface contact. The elastic deformation of the bent structure of the abutting portion 132 enables close contact between the circuit board 40 and the conductive elastic component 130, ensuring a stable electrical connection.

Further, the main body portion 212 may have a groove structure 2122. The groove structure 2122 is arranged around the bottom side of the main body portion 212. The groove structure 2122 serves as a fixing structure when the power connector 400 is disposed in the power adapter.

### Fifth embodiment:

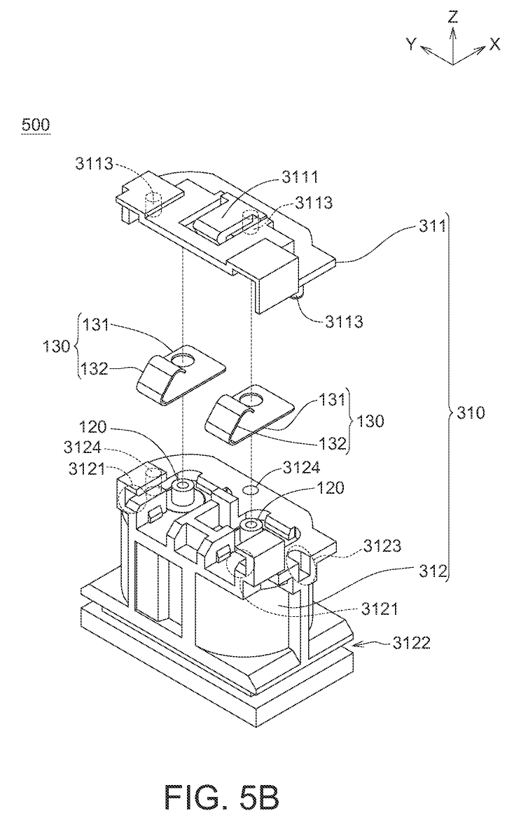

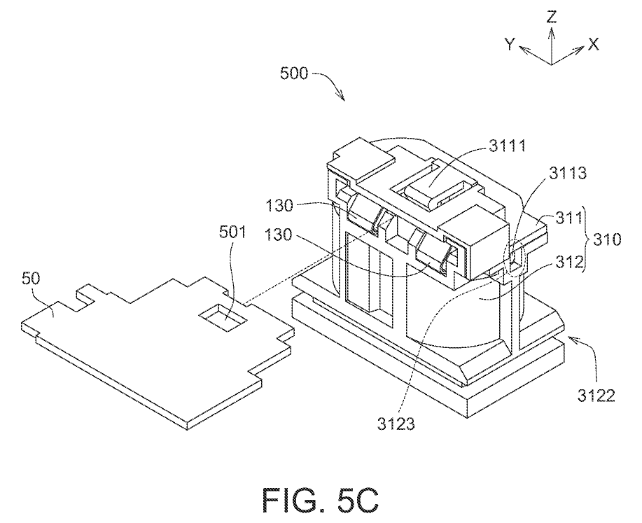

Please refer to FIG. 5A to FIG. 5C, which illustrate a power connector 500 according to the fifth embodiment of the present invention. FIG. 5A illustrates a perspective view of the power connector 500. FIG. 5B illustrates an exploded view of the power connector 500. FIG. 5C illustrates the power connector 500 and a circuit board 50 with which it is adapted to be connected.

The power connector 500 of this embodiment, for example, is an AC power connector and may serve as the AC inlet of a power adapter. The power connector 500 is adapted to be connected with a circuit board 50 of a power adapter. The power connector 500 includes a base 310, the aforementioned conductive pin 120, and the aforementioned conductive elastic component 130. That is, the difference between the power connector 500 of this embodiment and the power connector 100 of the first embodiment lies in the different configurations of the base. The conductive pin 120 is disposed in the base 310. The conductive elastic component 130 is electrically connected between the circuit board 50 and the conductive pin 120. The base 310, for example, is made of an insulated plastic material. The base 310 may include a cover portion 311 and a main body portion 312, which are fixedly connected to each other. The cover portion 311 and the main body portion 312 may be fixedly connected through ultrasonic welding. The cover portion 311 may have protruding post structures 3113. The main body portion 312 may have a blind-hole structure 3123 and recess structures 3124, corresponding to the protruding post structures 3113. When the cover portion 311 and the main body portion 312 are fixedly connected, one of the protruding post structures 3113 is inserted into the corresponding blind-hole structure 3123, and another two of the protruding post structures 3113 are fitted into the two corresponding recess structures 3124.

The conductive elastic component 130 is disposed between the cover portion 311 and the main body portion 312. The conductive elastic component 130 may protrude from the cover portion 311. An accommodating space is formed between the conductive elastic component 130 and the cover portion 311 for the circuit board 50 to be inserted and fixed. The main body portion 312 may have a sliding rail structure 3121. That is, the main difference between the power connector 500 of this embodiment and the power connector 400 of the fourth embodiment is that the sliding rail structure is formed on the main body portion rather than the cover portion. The sliding rail structure 3121 is formed at both ends of the top side of the main body portion 312, adjacent to the two conductive elastic components 130. The circuit board 50 can be inserted into the sliding rail structure 3121. When the circuit board 50 is inserted into the sliding rail structure 3121, the circuit board 50 is in contact with and presses down on the conductive elastic component 130. Due to its elasticity, the conductive elastic component 130 deforms under pressure to abut against the circuit board 50, ensuring a stable electrical connection between the circuit board 50 and the conductive elastic component 130.

Further, the cover portion 311 may have a hook structure 3111, which corresponds to a through-hole structure 501 of the circuit board 50. When the circuit board 50 is inserted into the main body portion 312, the hook structure 3111 can be secured in the through-hole structure 501, making the installation of the circuit board 50 onto the base 310 more secure, , but it is not limited thereto. In other embodiments, the hook structure may alternatively be formed on the main body portion 312, as long as the base 310 is provided with a hook structure.

When the circuit board 50 is inserted into the main body portion 312, the abutting portion 132 of the conductive elastic component 130 abuts against the circuit board 50. That is, the abutting portion 132 provides a contact place when the circuit board 50 is inserted into the cover portion 311. The contact between the abutting portion 132 and the circuit board 50 may be line contact or surface contact. The elastic deformation of the bent structure of the abutting portion 132 enables close contact between the circuit board 50 and the conductive elastic component 130, ensuring a stable electrical connection. The main body portion 312 may have a groove structure 3122, which is arranged around its bottom side. The groove structure 3122 serves as a fixing structure when the power connector 500 is disposed in the power adapter. Further, the bottom design of the main body portion 312 may be similar to that of the main body portion 212, meaning the conductive pin 120 may be exposed from an open area (not illustrated) at the bottom of the main body portion 312.

### Sixth embodiment:

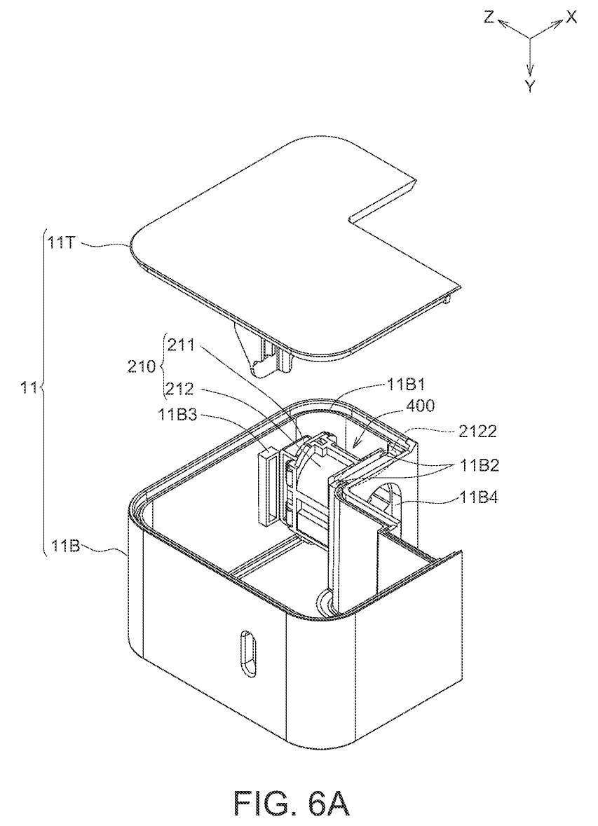

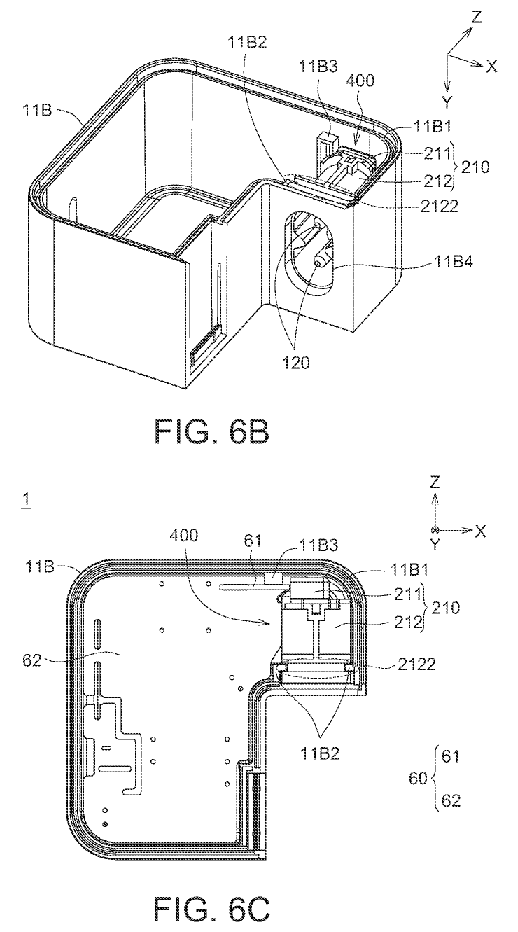

Please refer to FIG. 6A to FIG. 6C, which illustrate a power adapter according to the sixth embodiment of the present invention. FIG. 6A and FIG. 6B illustrate a casing 11 of a power adapter 1 and the power connector 400. FIG. 6C illustrate a top view of the power adapter 1.

The power adapter 1 of this embodiment is, for example, an AC power adapter. The power adapter 1 may comprise a casing 11, a circuit board 60, and a power connector. In this embodiment, the power connector included in the power adapter 1 is the aforementioned power connector 400 for example, but it is not limited thereto. Other aforementioned power connectors may be used depending on implementation needs. The casing 11 is, for example, made of an insulated plastic material. The casing 11 may include an upper casing 11T and a lower casing 11B, which are engaged together. The circuit board 60 and the power connector 400 are disposed in the casing 11. Specifically, the lower casing 11B has an accommodating structure 11B1, and the power connector 400 may be disposed in the accommodating structure 11B1. The lower casing 11B also includes a slider structure 11B2. The groove structure 2122 of the base 210 of the power connector 400 corresponds to the slider structure 11B2. The power connector 400 can be inserted into the groove structure 2122 via the slider structure 11B2 to be positioned within the accommodating structure 11B1.

The casing 11 may include a limiting structure 11B3, which protrudes from the inner wall of the casing 11. When the circuit board 60 is inserted into the power connector 400 and disposed in the casing 11, the circuit board 60 can abut against the limiting structure 11B3. Specifically, the limiting structure 11B3 is formed on the inner wall of the lower casing 11B, but it is not limited thereto. In other embodiments, the limiting structure may be formed on the upper casing 11T, as long as the casing 11 includes a limiting structure. The limiting structure 11B3 provides support and positioning for the circuit board 60, preventing it from shifting inside the casing 11, which could affect the electrical connection between the circuit board 60 and the power connector 400. In this embodiment, the circuit board 60 may include a first circuit board portion 61 and a second circuit board portion 62 that are connected to each other. The first circuit board portion 61 is inserted into the base 210 of the power connector 400. The second circuit board portion 62 abuts against the lower casing 11B of the casing 11. Specifically, the first circuit board portion 61 (parallel to the X-Y plane) and the second circuit board portion 62 (parallel to the X-Z plane) may be vertically connected.

Further, the lower casing 11B may have an insertion hole 11B4. The conductive pin 120 of the power connector 400 is exposed from insertion hole 11B4, allowing an external power cable to be connect to the conductive pin 120.

### Seventh embodiment:

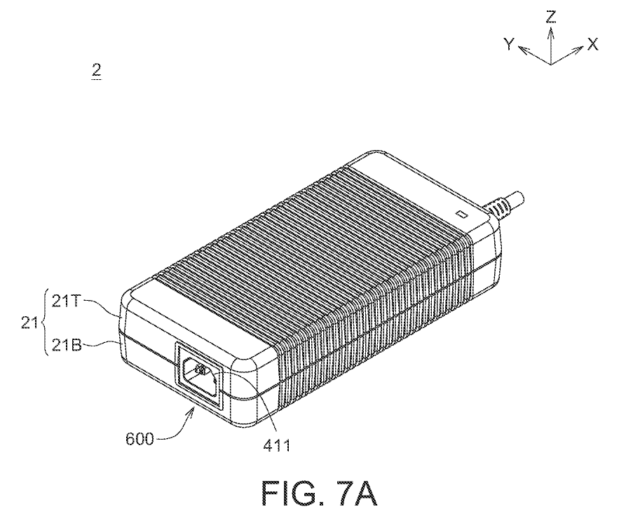

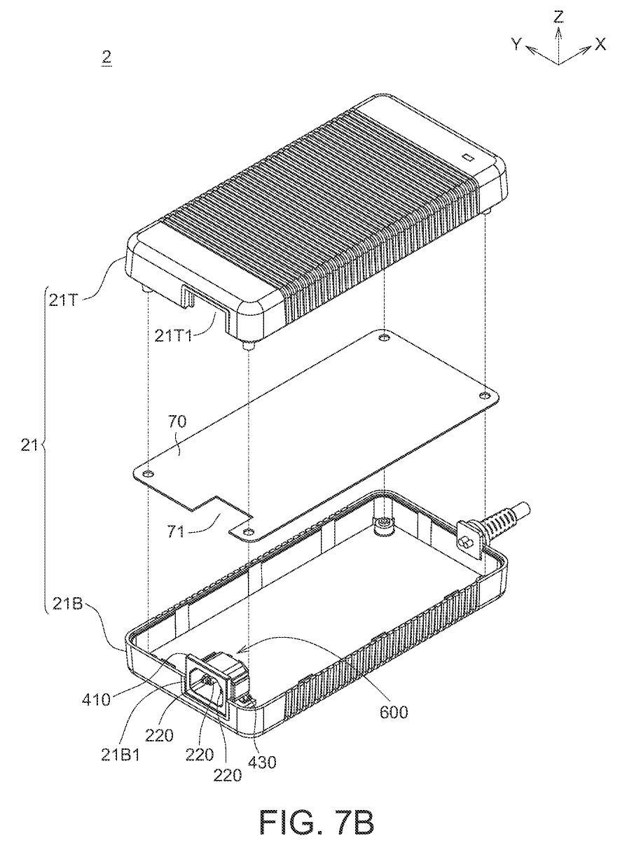

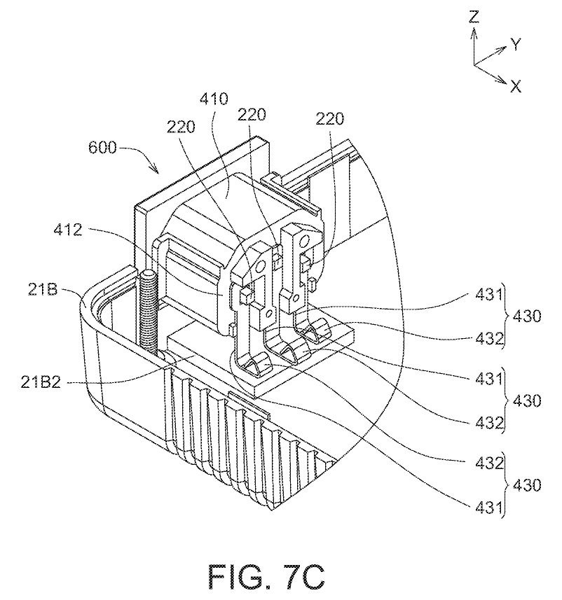

Please refer to FIG. 7A to FIG. 7C, which illustrate a power adapter 2 according to the seventh embodiment of the present invention. FIG. 7A illustrates a perspective view. FIG. 7B illustrates an exploded view of the power adapter 2. FIG. 7C illustrates a partial view of the power adapter 2.

The power adapter 2 of this embodiment is, for example, an AC power adapter. The power adapter 2 may comprise a casing 21, a circuit board 70, and the power connector 600. The power connector 600 functions as the AC input port of the power adapter 2. The circuit board 70 and the power connector 600 are disposed in the casing 21 and are electrically connected. The casing 21 is, for example, made of an insulated plastic material. The casing 21 may include an upper casing 21T and a lower casing 21B, which are engaged together. Specifically, the upper casing 21T and the lower casing 21B may be fastened together using screws. The upper casing 21T has a notch structure 21T1. The lower casing 21B has a notch structure 21B1. When the upper casing 21T and the lower casing 21B are engaged together, the notch structures 21T1 and 21B1 collectively form an accommodating structure, in which the power connector 600 can be disposed. The circuit board 70 is positioned around the power connector 600, and a recess structure 71 of the circuit board 70 avoids the power connector 600.

The power connector 600 comprises a base 410, conductive pins 220, and conductive elastic components 430. The conductive pins 220 are disposed on the base 410. The base 410 is, for example, made of an insulated plastic material. The conductive pins 220 may be exposed from an opening 411 in the base 410. In this embodiment, the power connector 600 comprises three conductive pins 220, which correspond to the live wire (L), neutral wire (N), and ground wire (G) of the power supply. The conductive pins 220 are, for example, made of a conductive metal material. The conductive elastic components 430 form the electrical connection between the circuit board 70 and the conductive pins 220. In this embodiment, the power connector 600 includes three conductive elastic components 430, with each conductive pin 220 passing through a corresponding conductive elastic component 430.

The conductive elastic components 430 are disposed on the base 410. Specifically, the conductive elastic components 430 abut against the surface 412 of the base 410, which is opposite to the opening 411 where the conductive pins 220 are exposed. The conductive elastic components 430 are, for example, made of a conductive metal material. Each conductive elastic component 430 includes a fixed portion 431 and an abutting portion 432. The abutting portion 432 extends from and bends relative to the fixed portion 431. The conductive elastic component 430 may be a flat spring structure. The fixed portion 431 is penetrated by the conductive pin 220, while the abutting portion 432 abuts against the circuit board 70. The circuit board 70 is positioned above the abutting portion 432, and the contact between them may be line contact or surface contact. The elastic deformation of the bent structure of the abutting portion 432 enables the circuit board 70 to make close contact with the conductive elastic component 430, ensuring a stable electrical connection. When the circuit board 70 is disposed in the casing 21, the circuit board 70 is in contact with and presses down on the conductive elastic components 430. Due to its elasticity, the conductive elastic components 430 deform under pressure to abut against the circuit board 70, ensuring a stable electrical connection between the circuit board 70 and the conductive elastic components 430.

Further, the lower casing 21B may include a platform structure 21B2. When the power connector 600 is disposed in the casing 21, the conductive elastic components 430 abut against the platform structure 21B2. The platform structure 21B2 provides support for the conductive elastic components 430 and prevents movement, ensuring that the power connector 600 does not shift inside the casing 21, which could otherwise affect the electrical connection between the conductive elastic components 430 and the circuit board 70.

### Eighth embodiment:

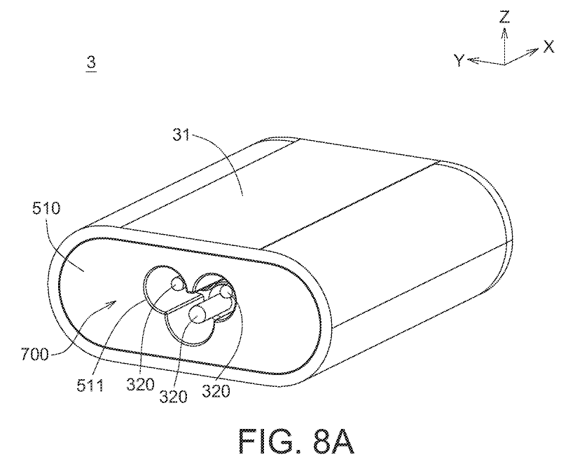

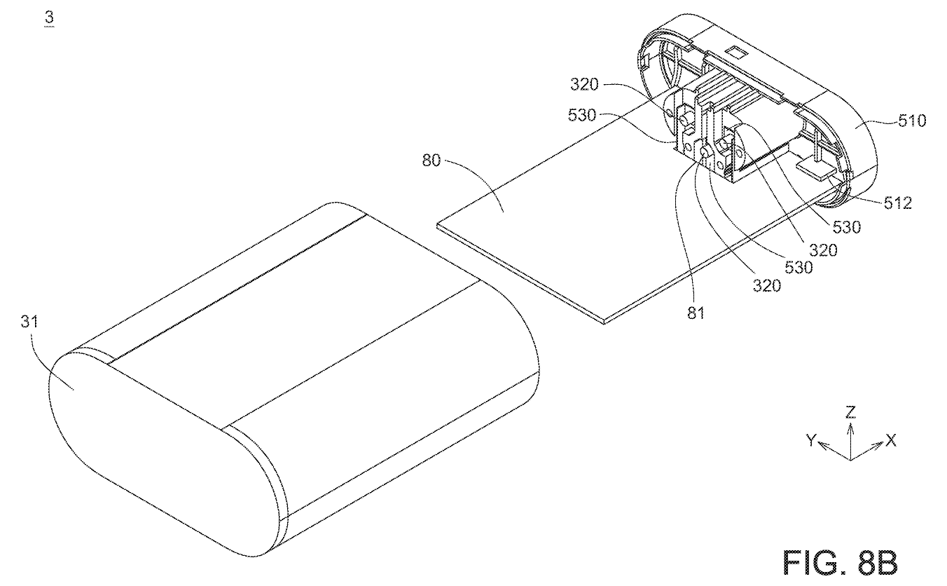

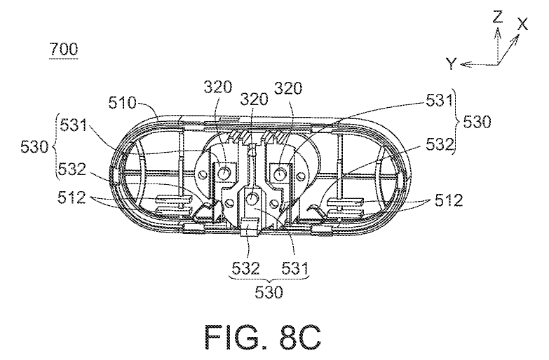

Please refer to FIG. 8A to FIG. 8C, which illustrate the power adapter 3 according to the eighth embodiment of the present invention. FIG. 8A illustrates a perspective view of the power adapter 3. FIG. 8B illustrates an exploded view. FIG. 8C illustrates a perspective view of the power connector 700 of the power adapter 3.

The power adapter 3 in this embodiment is, for example, an AC power adapter. The power adapter 3 may comprise a casing 31, a circuit board 80 and a power connector 700. The power connector 700 functions as the AC input port of the power adapter 3. The circuit board 80 and the power connector 700 are disposed in the casing 31. The casing 31 is, for example, made of an insulated plastic material. The power connector 700 and the circuit board 80 are electrically connected. The circuit board 80 is positioned around the power connector 700, and a recess structure 81 of the circuit board 80 avoids the power connector 700.

The power connector 700 comprises a base 510, conductive pins 320, and conductive elastic components 530. The base 510 is, for example, made of an insulated plastic material, and may use the same material as the casing 31. The base 510 and the casing 31 are engaged together, for example, by snap-fitting the base 510 into the casing 31. The base 510 and the casing 31 together form the smooth exterior shape of the power adapter 3. The circuit board 80 is positioned between the base 510 and the casing 31. The base 510 may include a sliding rail structure 512, which protrudes from the inner wall of the base 510. The circuit board 80 abuts against the sliding rail structure 512. The sliding rail structure 512 provides support and positioning for the circuit board 80, preventing it from shifting inside the casing 31, which could otherwise affect the electrical connection between the circuit board 80 and the power connector 700.

The conductive pins 320 are disposed on the base 510. Specifically, the conductive pins 320 are positioned on the inwardly protruding central portion of the base 510. The recess structure 81 of the circuit board 80 surrounds this central portion. The conductive pins 320 may be exposed from an opening 511 in the base 510. In this embodiment, the power connector 700 includes three conductive pins 320, which correspond to the live wire (L), neutral wire (N), and ground wire (G) of the power supply. The conductive pins 320 are, for example, made of a conductive metal material. The power connector 700 includes three conductive elastic components 530, with each conductive pin 320 passing through a corresponding conductive elastic component 530.

The conductive elastic components 530 are disposed on the base 510. Specifically, the conductive pins 320 are also positioned on the inwardly protruding central portion of the base 510. The conductive elastic components 530 form an electrical connection between the circuit board 80 and the conductive pins 320. The conductive elastic components 530 are, for example, made of a conductive metal material. Each conductive elastic component 530 includes a fixed portion 531 and an abutting portion 532. The abutting portion 532 extends from and bends relative to the fixed portion 531. The conductive elastic component 530 may be a flat spring structure. The fixed portion 531 is penetrated by the conductive pin 320, while the abutting portion 532 abuts against the circuit board 80. The three abutting portions 532 may extend in different directions, forming a radial configuration in this embodiment. The circuit board 80 is positioned above the abutting portion 532, and the contact between them may be line or surface contact. The elastic deformation of the bent structure of the abutting portion 532 enables the circuit board 80 to make close contact with the conductive elastic component 530, ensuring a stable electrical connection. When the circuit board 80 is disposed in the casing 31, the circuit board 80 is in contact with and presses down on the conductive elastic components 530. Due to its elasticity, the conductive elastic components 530 deform under pressure to abut against the circuit board 80, ensuring a stable electrical connection between the circuit board 80 and the conductive elastic components 530.

As disclosed, the power connector in these embodiments uses conductive elastic components to form electrical connections between the conductive pins and the circuit board of the power adapter. This design eliminates the need for wiring space required by conventional cables, reduces material costs, mitigates electromagnetic interference caused by traditional cables, and prevents solder joints from breaking due to repeated plugging and unplugging.

It will be apparent to those skilled in the art that various modifications and variations may be made to the disclosed embodiments. It is intended that the specification and examples be considered as exemplars only, with a true scope of the disclosure being indicated by the following claims and their equivalents.

What is claimed is:

1. A power connector adapted to be connected with a circuit board of a power adapter, comprising:
a base;
a conductive pin disposed in the base; and
a conductive elastic component electrically connected between the circuit board and the conductive pin, wherein the conductive pin penetrates through the conductive elastic component.

2. The power connector of claim 1, wherein the conductive elastic component includes a fixed portion and an abutting portion, the abutting portion extends and bends from the fixed portion, the conductive pin penetrates through the fixed portion, and the abutting portion abuts against the circuit board.

3. The power connector of claim 1, wherein the conductive elastic component includes a fixed portion and a slot portion, the slot portion extends and bends from the fixed portion, the conductive pin penetrates through the fixed portion, and a protruding section of an edge of the circuit board is inserted into the slot portion.

4. The power connector of claim 1, wherein the conductive elastic component includes a fixed portion and a clamping portion, the clamping portion extends from the fixed portion and protrudes from the base, and the circuit board is clamped by the clamping portion.

5. The power connector of claim 1, wherein the base includes a cover portion and a main body portion, the cover portion and the main body portion are fixedly connected to each other, and the conductive elastic component is disposed between the cover portion and the main body portion.

6. The power connector of claim 5, wherein the cover portion has a sliding rail structure, the circuit board is inserted into the sliding rail structure, and the conductive elastic component abuts against the circuit board.

7. The power connector of claim 6, wherein the cover portion has a hook structure corresponding to a through-hole structure of the circuit board, and the circuit board is inserted into the cover portion, the hook structure is latched into the through-hole structure.

8. The power connector of claim 5, wherein the main body portion has a sliding rail structure, the circuit board is inserted into the sliding rail structure, and the conductive elastic component abuts against the circuit board.

9. The power connector of claim 5, wherein the cover portion has a hook structure corresponding to a through-hole structure of the circuit board, and the circuit board is inserted into the main body portion, the hook structure is latched into the through-hole structure.

10. A power adapter, comprising:
a casing;
a circuit board disposed in the casing; and
a power connector disposed in the casing, comprising:
a base;
a conductive pin disposed in the base; and
a conductive elastic component electrically connected between the circuit board and the conductive pin, wherein the conductive pin penetrates through the conductive elastic component.

11. The power adapter of claim 10, wherein the casing includes an upper casing and a lower casing, the upper casing and the lower casing is fixedly connected to each other, the lower casing has an accommodating structure, and the power connector is disposed in the accommodating structure.

12. The power adapter of claim 11, wherein the lower casing has a slider structure, the base has a groove structure corresponding to the slider structure, and the power connector is disposed in the accommodating structure through the slider structure sliding into the groove structure.

13. The power adapter of claim 10, wherein the casing has a limiting structure, the limiting structure protrudes from an inner wall of the casing, and the circuit board abuts against the limiting structure.

14. The power adapter of claim 13, wherein the casing includes an upper casing and a lower casing, the upper casing and the lower casing is fixedly connected to each other, and the limiting structure is formed on an inner wall of the lower casing.

15. The power adapter of claim 10, wherein the base has a limiting structure, the limiting structure protrudes from an inner wall of the base, and the circuit board abuts against the limiting structure.

16. The power adapter of claim 10, wherein the circuit board includes a first circuit board portion and a second circuit board portion that are engaged with each other, the first circuit board portion is inserted into the base, and the second circuit board portion abuts against the casing.

17. The power adapter of claim 16, wherein the first circuit board portion and the second circuit board portion are vertically engaged.

18. The power adapter of claim 16, wherein the casing has an insertion hole, and the conductive pin is exposed from the insertion hole.

19. The power adapter of claim 10, wherein the casing and the base are fixedly connected to each other.

20. The power adapter of claim 10, wherein the circuit board has a recess structure, and the recess structure avoids the power connector.
